(19) United States
(12) Patent Application Publication
(10) Pub. No.: US 2004/0013854 A1
(43) Pub. Date: Jan. 22, 2004

(54) Highly reflective and highly emissive film laminate

(76) Inventors: Natalino Zanchetta, Reno, NV (US); Shaik Mohseen, Mountain Top, PA (US)

Correspondence Address: David I. Roche, BAKER & McKENZIE, 130 E. Randolph Drive, Chicago, IL, 60601, US

(21) Appl. No.: 10/195,930

(22) Filed: Jul. 16, 2002

(51) Int. Cl. B32B 3/00

(52) U.S. Cl. 428/156; 428/172

(57) ABSTRACT

A reflective and emissive surface film laminate specially designed to form a top surface of modified bituminous roof covering composite such as membranes, underlayments and shingles to constitute a roof with thermal characteristics with substantially reduced amount of radiant energy entering a structure with such a covering.

### BACKGROUND AND SUMMARY OF THE INVENTION

This invention relates to surface film laminates used in roofing membranes adapted for the waterproofing and sealing of substrate structures, particularly in roofing applications and to the method of manufacturing such membranes. More particularly, the present invention is in the field of energy-efficient roofing membranes and shingles based on atactic polypropylene modified or styrene-butadiene-styrene modified or thermoplastic polyolefin modified bituminous compound, with a factory-applied surface film laminate of the present invention that provides high reflectivity and emissivity on the weathering surface of the membrane, resulting in reduced energy needed to maintain optimal building temperatures, effecting significant economical and environmental benefits, in addition to complying with the requirements of various regulatory bodies.

Energy consumption and costs have received much attention because when energy prices go up, a corresponding need has arisen for roof systems that assist in energy conservation. There has been a need for a roofing material with high reflectivity and high emissivity, especially in regions where cooling-degree days exceed heating-degree days. Several studies have been conducted that correlated the surface temperature of a building's roof to the energy required to maintain comfortable living conditions inside the building. Such studies have revealed that cooler roofs resulted in lower energy costs associated with heating the interior of the building. After extensive research and analysis, several governmental and non-governmental entities, research organizations, regulatory bodies and building standards-setting organizations have recognized the significance of benefits associated with energy savings through the use of cool roofing materials that help lower energy costs by maintaining lower surface temperatures. One of the several energy programs that have been recently launched is the Energy Star program implemented by the U.S. Department of Energy and the U.S. Environmental Protection Agency. Energy Star program is a national campaign to help protect the environment through energy efficient products and practices. Other nationwide programs include the Leadership in Energy and Environmental Design (LEED) program, ‘Green Roof’ program, ‘Cool Communities’ program coordinated by the U.S. Department of Energy, etc. Several local jurisdictions have also launched energy efficient roof programs. In 1994, the State of Georgia enacted what has come to be known as the Georgia White Roof Amendment that requires the use of additional insulation for roofing systems whose surfaces do not have test values of 75% or more for both reflectivity and emissivity. In January of 2001, California launched its California Energy Commission's Cool Savings Program to allocate money towards the use of cooler roofing systems. The program, which is the first of its kind, grants a building owner a rebate of up to 20 cents/foot² of roof surface that contains cool roofing materials. Similarly, the Sacramento Municipal Utility District has instituted a rebate program to contractors of up to 20 cents/foot² for roof products that contain cool roofing materials. The city of Tucson, Ariz. is investigating ‘cool community’ mitigation measures to reduce heat island effect of hot roofing and paving materials. Other jurisdictions have gone even further by making energy efficient roofing program mandatory on all new roof installation. For example, the City of Chicago has enacted a new ordinance that requires the use of roofing materials to meet stringent requirements for energy efficiency such as 65% initial solar reflective properties and 50% solar reflective properties after three years, and 90% emissivity. Several other metropolitan areas are set to follow these examples.

The term “cool roof” is used in the trade, in general, to refer to a roof surface that is highly reflective and highly emissive. A roof surface's primary characteristics that are critical to energy performance are solar reflectivity and emissivity. Reflectivity, also known as albedo, is the amount of incoming solar energy a roofing material's surface reflects and is measured as a percentage of solar heat reflected off of the roof. Emissivity is the amount of absorbed energy a roofing material radiates from itself because of the material's own heat and temperature, and is measured as a percentage of heat that comes off of a roof. In other words, reflectivity is the percentage of the sun's heat a roof keeps off the building structure, whereas emissivity is the percentage of heat a roof lets out of a building structure.

For a building to have improved thermal efficiency its roof system should have a high reflectivity, i.e., it should keep out a high percentage of the solar energy to which it is exposed, and the roof system should have high emissivity, i.e., it should let out a high percentage of the heat it has absorbed. Most surfaces have high reflectivity but low emissivity and vice-versa. For example, black asphaltic surface has low reflectivity but high emissivity, whereas aluminum metallic roof surface has high reflectivity but low emissivity. Conventional roof surfaces with low reflectivity and high emissivity heat to 160 to 190 degrees Fahrenheit during the summer. Metal or aluminum coated roofs with high reflectivity and low emissivity still warm to 140 to 170 degrees Fahrenheit. Cool roofs with both high reflectivity and high emissivity only reach 100 to 120 degrees Fahrenheit in the summer sun.

In order to qualify as a cool roof, it is essential for the roofing material to possess both high reflectivity and high emissivity characteristics. Reflectivity is measured using ASTM E903 or ASTM E1918 and emissivity is determined in accordance with ASTM E408. A cool roof, as defined by the U.S. Department of Energy as part of its Energy Star program, is a roof made with a product that meets or exceeds the Department's solar reflectance requirements, without compromising product quality or performance. Energy Star labeled roof product is a reflective roof material that lowers roof surface temperature by up to 100 degrees Fahrenheit, thereby decreasing the amount of heat transferred into a building's interior. Energy Star labeled roof product provides several benefits, including cost and energy savings, extended roof life, and decreased pollution.

Roofs undergo significant expansion and contraction as they heat and cool throughout the day. Heat absorbed can accelerate degradation due to UV rays and water. Reflective roof can reduce the amount of thermal shock that occurs on the roof surface and make the roof last longer. Also cool roofs are long lasting because they reflect the sun's ultraviolet rays that are responsible for breakdown of most conventional materials.

To summarize, cool roofs offer many benefits, including decreased roofing maintenance and replacement costs, improved building comfort, reduced impact on surrounding air temperatures, reduced peak electricity demand, reduced waste stream of roofing debris due to extended roof life, etc.

Reflectivity and emissivity are dependent on the surface characteristics of the roofing membrane. Uncoated APP and SBS modified roofing membranes have reflectivity values of 0.05 to 0.10 whereas white granulated roofing membranes possess reflectivity in the range of 0.20 to 0.40. There are several coatings that are available in different colors that can be applied to the exposed surface of the sheet to improve the reflectivity and emissivity factors. Modified bitumen roofing products do not meet criteria for cool roofing without application of external coatings on the top surface of the roofing membrane after installation of the same at the jobsite. Such external treatment that is generally in the form of coatings has several drawbacks. Coatings are generally sprayed or rolled onto the main roof's surface area and are difficult to handle. These emit volatile organic compounds (VOC) that are harmful to the environment. Coatings are very expensive, and the process of application of coatings is labor intensive and time-consuming because of extensive surface preparation required. Most manufacturers of coatings stipulate stringent requirements for preparation of the surface of the membrane before application of the coatings—such instructions, when improperly followed, result in not achieving the desired results. Also most coatings are recommended to be applied a few days after installation of the roofing membrane, which extends the time needed for prompt completion of the roofing project. Moreover, most coatings lose their effectiveness in 5-8 years and therefore the roof needs to be recoated to attain the desired reflective and emissive properties. Also the amount of coating applied is very subjective; it depends on several factors such as the laborer, type of membrane, surface texture of the membrane, etc. All of the above factors determine the effectiveness of the performance of coatings over a period of time.

Although there are film materials commercially available that possess high reflective and high emissive properties, such films cannot be directly applied to the asphaltic compound due to a variety of reasons, such as processing difficulties due to heat sensitivities of the film, potential for delamination of the film caused by exudation of oil from modified asphaltic compound, discoloration of the film due to exudation of oil from modified asphaltic compound, etc. A roofing material with a metallic or aluminum top layer and a bitumen coating bottom layer is known in the prior art. For example, U.S. Pat. No. 5,096,759, discloses a membrane containing a laminated top aluminum foil surface and a bottom bitumen coating surface. The surface film laminate applied on the top layer of the membrane to impart cool roof properties constitutes the weathering surface. Such film can a lamination of multiple layers consisting of fabric, foil and film materials. The fabric material generally used is commercially available polyester or polypropylene that is utilized in a variety of applications including roofing, furniture, etc. Aluminum foil used is of commercial grade widely used in the manufacture of food packaging to ensure freshness of the contents since such foil offers excellent barrier characteristics. Film employed can be polyester (polyethylene terephthalate—PET) or polyvinyl fluoride (PVF). Polyester (PET) in sheet form has multiple applications and is widely used. PVF preferred is a special grade produced by DuPont De Nemours & Company under the trade name, Tedlar. Tedlar possesses excellent properties such as high reflectivity, high emissivity, excellent ultraviolet light resistance, good heat resistance, fire retardancy, good dimensional stability, good bonding characteristics to various substrates using adhesives, resistance to attack by solvents, fungi, etc. This material also has proven outdoor exposure and owing to such excellent properties, this material is widely used in outdoor applications. To avoid differential stresses arising from changes in temperature, the various substrates are preferably made of materials having similar or identical thermal expansion properties. Several laminating companies can be used for the production of such laminates.

There are currently several products available in the market that have fabric material on the top surface of the asphaltic compound in order to provide high temperature resistance and anti-slip properties. It is well known that most coatings used to meet cool roof criteria are silver or white in color. In order to obtain a silver color finish, it is possible to metallize one or both sides of a fabric material which can be made of polypropylene or polyester. Alternately a white color fabric can be used to get a white color finish. The advantage of using a fabric over other materials such as film or foil is that their coarse texture assists in adhering the surface film laminate to the asphaltic substrate. Film or foil materials typically have very smooth surfaces, which may provide insufficient surface area for bonding, and therefore could delaminate from the surface of the asphaltic compound after cooling of the roofing membrane.

Coincidentally, polyester fabric has thermal expansion characteristics similar to that of the modified bituminous compound. Moreover, it is noteworthy that one of the preferred choices of reinforcing carrier in a modified bituminous roofing membrane is polyester. Another reason for choosing polyester fabrics is because they are relatively inexpensive. However, fabrics are not designed for outdoor applications, and therefore do not have long life when exposed to the elements, and hence will fail in a short period. Failure could be caused by a variety of factors such as ultraviolet light, moisture, attack from solvents and fungi, foot traffic, migration of oil and plasticizers in the modified bituminous compound causing delamination, etc.

For purposes of the present invention, the preferred materials are polyester (PET) or polyvinyl fluoride (PVF) and foil such as aluminum. Aluminum has its advantages in that it is readily available and is affordable. It also has good bonding characteristics to surfaces such as fabrics, good impermeability and excellent reflective properties. The main drawback associated with aluminum foil is its relatively low emissive characteristics. Moreover, use of a thin layer of aluminum can cause the surface film laminate to fail by erosion or damage due to traffic. Conversely, use of a thicker foil increases cost in addition to posing other problems such as the product becomes very rigid and difficult to handle.

The present invention offers a surface laminate that meet the requirements of high reflectivity and high emissivity required for conventional roofing membranes and shingles to qualify as ‘cool roofs’ without the drawbacks associated with the usage of coatings. The laminate of the present invention is made in the factory (saving labor costs in the field and providing quality control that is not available when field applied coatings are used) and has several advantages in that it is environmentally friendly, relatively inexpensive, highly reliable, and does not involve additional time for installation of the roof. Such treatment is performed under rigid factory conditions and is not subject to the numerous variables in the field as with application of an external coating. The surface laminate that is the subject of this invention provides enhanced reflectivity and emissivity because of its unique design features. This inventive laminate can be used on APP modified and SBS modified membranes, self-adhesive membranes, underlayments such as employed under tile roofing and metal panels, as well as on shingles.

It is important to note that “cool roof” requirements for shingles are not as stringent as for modified membrane roofing, i.e., the reflectivity and emissivity requirements are lower for shingles that for membranes for flat roofs. Table 1 provides the requirements of the Energy Star program for roofing products and Table 2 provides the requirements of the City of Chicago for cool roof products. This is due to the fact that shingles are applied on steep slope, which is defined as a roof pitch of 2:12 inches and greater. Though the present inventive films are silver or white colored, which may not be desirable in residential applications, it is possible to have sufficiently reflective and emissive films in a variety of other colors for use in shingle roofing for residential applications.

It is, therefore, one object of the present invention to provide a high reflective and high emissive surface laminate that can be applied to the top surfaces of roofing membranes to prevent heat from being absorbed by the roofing material by enhancing reflectivity and emissivity characteristics.

Another object of the present invention is to provide a high reflective and high emissive surface laminate that can be applied to the top surfaces of roofing shingles to prevent heat from being absorbed by the material by enhancing reflectivity and emissivity characteristics.

Yet another embodiment of the present invention is to provide a high reflective and high emissive surface laminate in the form of a seam tape that can be used in repair or patching work on existing and new roofing structures. Such seam tapes are usually 6 to 12 inches in width. When torch grade cool roofing modified membranes are applied on the rooftop, the backside of one roll is torched and attached to the overlap area of an adjacent roll. Similarly when mop grade cool roofing modified membranes are applied on the rooftop, the backside of one roll is hot mopped and attached to the overlap area of an adjacent roll. During this process of application, the laminate surface on the overlap areas (i.e. the side lap and end lap) of the composite membrane could experience heat distortion. Seam tapes of the present invention could be applied over the end lap and side lap joint areas to provide a continuous cool roofing membrane covering. Use of such seam tape also serves the purpose of protecting the exposed edges of the membrane from deterioration due to ultraviolet rays.

In one preferred embodiment, the surface laminate of this invention is a hybrid of a polyolefinic fabric and a polyolefinic sheet material, bonded together using a bonding adhesive, with or without a coating of an ultraviolet resistant material on the exposed side of the top layer. In another preferred embodiment, the surface laminate of this invention is a hybrid of a polyolefinic fabric, a polyolefinic sheet and an aluminum foil, bonded together using bonding adhesive, with or without a coating of an ultraviolet resistant material on the exposed side of the top layer. The polyolefinic fabric can be made of polypropylene or polyester, of unit weight ranging from 15 grams/meter² to 250 grams/meter², depending upon the method of application to the modified bituminous substrate. Bonding adhesive used as bonding agent can be low density polyethylene (LDPE), acrylic adhesive or ethyl acrylic acid (EAA), of thickness in the range of 0.5 mil (12.5 microns) to 1.5 mil (37.5 microns). Polyolefinic film on the top surface can be commercially available polyester (PET) or Polyvinyl fluoride (PVF), of thickness ranging from 1 mil (25 micron) to 2 mil (50 micron), clear or white in color, depending upon the desired color of the laminate, and with or without ultraviolet inhibitors inside the polymeric material. Clear polyolefinic film can be metallized using vapor deposition techniques to yield a silver color look. Aluminum foil used is commercially available grade of 1 mil in thickness. To avoid differential stresses arising from changes in temperature, the various substrates are preferably made of materials having similar or identical thermal expansion properties.

Fabric employed in this application can be polypropylene or polyester based. However, due to the superior thermal characteristics of the polyester material, fabric selected for this lamination was a polyester of unit weight ranging from 30 to 250 grams/meter² depending on the preferred method of subsequent lamination of the surface film to the modified bituminous compound. If the preferred mode of manufacture of the ‘cool roof’ modified bitumen membrane is by laminating the surface film laminate of the present invention to the top of the modified bitumen compound, a 30 to 50 grams/meter² polyester mat is preferred. However, if the preferred mode of manufacture of the ‘cool roof’ modified bitumen membrane is by coating the modified bitumen compound on the surface film laminate of the present invention, a 140 to 250 grams/meter² polyester mat is preferred.

Polyolefinic film can be polyester (PET) or polyvinyl fluoride (PVF) material. However, there are significant differences in cost and performance characteristics of PET and PVF sheets. While both have good inherent ultraviolet resistant properties, PVF film is 6 to 10 times costlier than its PET counterpart. Both films are available in a variety of colors. However this invention focuses on white and silver color film surfaces. It is noteworthy that white and silver color sheets meet the high reflectivity and emissivity requirements whereas other colors do not. However other colored sheets may be suitable for use in cool roofing shingles, which require significantly lower reflectivity and emissivity values. See Table 1 and 2 for minimum acceptance values. The success of the surface laminate depends primarily on the ultraviolet resistant nature of the polyolefinic film. White sheets have pigments such as titanium di-oxide added in order give the white color, and the pigment is carried by a sheet. “Carried by”, as used herein includes mixed into the material comprising a sheet and applied as a coating to a sheet. Such films are opaque and do not allow UV light to pass through them. These films are also available with built-in ultraviolet inhibitors to absorb any UV light that may enter inside.

Another important factor when choosing a sheet is thickness. A minimum of 1 mil (25 micron) is required to achieve the desired properties. Use of a thin sheet can cause premature failure through erosion or damage by traffic. Use of a thicker sheet dramatically increases cost in addition to posing other problems in that the product becomes very rigid and difficult to handle. A PVF sheet of 1 mil (25 micron) thickness was selected for this application due to its proven outdoor weatherability, high reflectivity, high emissivity, excellent ultraviolet light resistance, good heat resistance, fire retardant properties, good dimensional stability, good bonding characteristics to various substrates using adhesives, resistance to attack by solvents, fungi, etc. A white color PVF sheet is used to get a white color film laminate surface and a metallized, clear PVF sheet or clear PVF film/aluminum foil combination is used to give a silver color surface laminate. After metallization of the PVF film using vacuum metal deposition technique to achieve silver color finish, such sheets are oriented in a manner that the metallized surface faces downward in the direction of the PET fabric, i.e., the metallized surface comes into contact with the bonding adhesive. Because the sheet is metallized on its underside, the silver color is protected from becoming discolored or damaged during manufacture and installation of the roofing membranes. Also, metallizing the underside permits the metallized surface not to be exposed to the elements where it might be eroded by action of the weather or wear away by foot traffic.

Aluminum foil employed is of commercially available grade of thickness ranging from 0.5 mil to 1.5 mil, with a preferred thickness of 1 mil. Such foil can be specially formulated with alloys to give added flexibility to the structure in order to facilitate ease of manufacture and ease of application of the roofing membrane at the jobsite.

The various layers can be bonded together with an adhesive such as acrylic or ethyl acrylic acid (EAA) or low density polyethylene (LDPE). While an acrylic adhesive is the most expensive option, it provides the best bonding strength based on prior art. Acrylics have excellent emissive properties as well. Since bonding strength is very important for the long-term performance of the membrane, the preferred bonding agent is a clear, acrylic adhesive of thickness 0.5 mil (12.5 microns) to 1.5 mil (37.5 microns). Such adhesives can also consist of UV stabilizers. UV stabilizers can be added to the adhesive to prevent delamination of the film from the fabric in case of attack of the adhesive layer due to UV light penetration through the existing upper layers.

The exposed surface of this surface laminate can be coated with an external layer of an ultraviolet resistant low density polyethylene or other proprietary ultraviolet resistant coatings in the order of 0.5 mil (12.5 microns) to 1 mil (25 microns) thickness to impart an additional layer of protection from ultraviolet light. An added advantage of using a UV resistant coating based on low density polyethylene (LDPE) is that LDPE has excellent emissive properties as well.

Furthermore, the upper surface of the laminate is preferably embossed to enhance aesthetics, provide slip resistance to the surface in addition to masking any surface imperfections.

When such film laminates are applied to the top asphaltic compound layer of modified bitumen membranes, roofing products that meet high reflectivity and emissivity criteria for cool roofing is achieved.

### BRIEF DESCRIPTION OF THE DRAWINGS

FIG. 1 shows an embodiment of the inventive silver surface film laminate.

FIG. 2 shows an embodiment of the inventive white surface film laminate.

FIG. 3 shows another embodiment of the inventive silver surface film laminate.

FIG. 4 shows another embodiment of the inventive white surface film laminate.

FIG. 5 shows an embodiment of the inventive surface film laminate to be used as a seam tape.

FIG. 6 shows another embodiment of the inventive surface film laminate to be used as a seam tape.

FIG. 7 is a process of manufacture for one embodiment of the inventive surface film laminate.

### DETAILED DESCRIPTION OF THE INVENTION

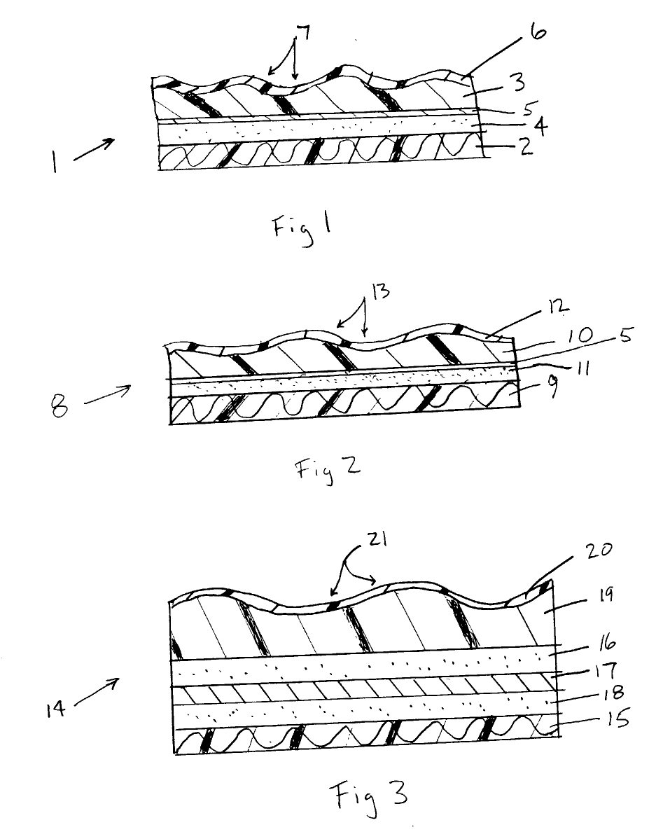

FIG. 1 shows one embodiment of the surface laminate 1, which is silver in color. A PET fabric 2 is laminated to a translucent and preferably clear, PVF sheet 3 using an adhesive 4. The underside 5 (hereinafter also referred to as metallized surface 5) of the PVF sheet 3 is metallized using a metal deposition technique (such as vapor deposition, perhaps in vacuum) to give a silver color to the laminate in order to establish reflectivity. The metallized PVF sheet 3 is oriented such that the metallized surface 5 faces downward in the direction of the PET fabric 2, i.e., the metallized surface 5 comes into contact with the bonding adhesive 4. An UV resistant coating 6 is applied on the upper side 8 of the PVF sheet 3 and an emboss pattern 7 can be applied on the top surface to enhance aesthetics and provide anti-slip properties. The preferred embodiment of a silver colored laminate surface 1 is a metallized, clear polyvinyl fluoride (PVF) sheet 3 of 1 mil (25 microns) thickness, with built-in ultraviolet inhibitors to prevent UV degradation, with or without a 0.7 mil thick clear, UV inhibiting coating 6 on the top surface. This metallized sheet 3 is then laminated to a polyester fabric 2 using a clear, adhesive 4 of 0.5 mil (12.5 microns) to 1.5 mil (37.5 microns) thickness. The surface laminate 1 has a thickness between 6 mil (0.15 mm) and 10 mil (0.25 mm).

Another embodiment of the surface laminate is shown in FIG. 2, which is white in color. A PET fabric 9 is laminated to a white PVF sheet 10 using an adhesive 11. An UV resistant coating 12 is applied on the exposed side of the PVF sheet 10 and an emboss pattern 13 can be applied on the top surface to enhance aesthetics and provide anti-slip properties. Although it is not necessary to metallize the bottom surface of the PVF sheet 10, metallization is preferred in order to block any UV light from penetrating to the adhesive layer. Of course, the metallized PVF sheet 10 is oriented such that the metallized surface faces downward in the direction of the PET fabric 9, i.e., the metallized surface comes into contact with the bonding adhesive 11. The preferred embodiment of a white surface laminate 8 is a metallized, white polyvinyl fluoride (PVF) sheet 10 of 1 mil (25 microns) thickness, with built-in ultraviolet inhibitors to prevent UV degradation, with or without a 0.7 mil thick clear, UV inhibiting coating 12 on the top surface. This metallized sheet 10 is then laminated to a polyester fabric 9 using a clear, adhesive 11 of 0.5 mil (12.5 microns) to 1.5 mil (37.5 microns) thickness. The surface laminate 8 has a thickness between 6 mil (0.15 mm) and 10 mil (0.25 mm).

Furthermore, a white surface laminate 8 can be achieved by choosing a bonding adhesive 11 that is white in color. The white bonding adhesive provides the white color to the laminate, rather than having to use a white-colored sheet. Alternatively, to obtain the white colored laminate surface 8, a white UV inhibiting coating can be applied on the top surface while using a clear PVF sheet 3 and clear adhesive 4. The white UV inhibiting coating on the top surface provides the white color to the laminate surface 8.

As shown in FIG. 3, another embodiment of the silver surface laminate 14 is a hybrid of a polyester fabric 15, aluminum foil 17 and a PVF sheet 19 bonded using an adhesive 16 and 18. The use of a mid-layer of aluminum foil 17 is to provide an additional barrier against migration of oil and plasticizers to the top surface of the structure and penetration of ultraviolet rays to the bottom surface of the structure. This construction can be coated with an external layer of an ultraviolet resistant polyethylene coating 20 or other proprietary ultraviolet resistant coatings of 0.5 mil (12.5 microns) to 1 mil (25 microns) thickness. An added advantage of using a coating 20 based on low density polyethylene (LDPE) is that LDPE has excellent emissive properties as well. A geometric pattern 21 can be embossed on the top surface of this sheet to enhance aesthetics, provide slip resistance to the surface in addition to masking any surface imperfections. Contrary to the prior embodiment, it is not necessary to metallize the surface to get the silver finish since the mid-layer, i.e., the aluminum foil 17, is silver in color, and therefore the laminate 14 will appear silver on the top surface. The preferred embodiment of such laminate 14 is a clear PVF sheet 19 of 1 mil (25 microns) thickness, with built-in ultraviolet inhibitors to prevent UV degradation and a 0.7 mil (17.5 microns) thick clear, UV inhibiting coating 20 on the top surface, laminated using a clear, bonding adhesive 18 of 1.5 mil (37.5 microns) thickness to a 1 mil (25 micron) thick aluminum foil 17, which in turn is laminated using a clear, bonding adhesive 16 of 1.5 mil (37.5 microns) thickness to a polyester fabric 15. Such surface laminate 14 preferably has a thickness in the range of 6 mil (0.15 mm) to 10 mil (0.25 mm). It is noteworthy that the clear sheet 19 of this embodiment is not metallized due to an added layer of silver color aluminum foil 17.

FIG. 4 illustrates another embodiment of a white surface laminate. The preferred embodiment includes a white PVF sheet 27 of 1 mil (25 microns) thickness, with built-in ultraviolet inhibitors to prevent UV degradation and a 0.7 mil thick clear, UV inhibiting coating 28 on the top surface, laminated using a clear, bonding adhesive 26 of 1.5 mil (37.5 microns) thickness to a 1 mil (25 microns) thick aluminum foil 25, which in turn is laminated using a clear, bonding adhesive 24 of 1.5 mil (37.5 microns) thickness to polyester fabric 23. Furthermore, a white color laminate surface 22 can be achieved by choosing a bonding adhesive 24 that is white in color. The white adhesive provides the white color to the laminate, rather than having to use a white-colored sheet. Alternatively, to obtain the white colored laminate surface, one can apply a white UV inhibiting coating 28 on the top surface while using a clear PVF sheet 19 and clear adhesive 24. The white UV inhibiting coating 28 on the top surface provides the white color to the surface laminate 22.

FIG. 5 shows another embodiment of the present invention, which is a seam tape 30 that is made from the abovementioned laminates. Such seam tape 30 can be white or silver surface laminates 31 and cut into narrower widths, preferably 6-9 inches. These tapes can be coated with a pressure-sensitive adhesive 32 on the bottom surface and a silicone release agent 33 on the top surface and self-wound.

FIG. 6 shows another embodiment of a seam tape 34 which consists of a PVF sheet 35 that is treated with a pressure-sensitive adhesive 36 on one side and a silicone release agent 37 on the opposite side. Such tapes are cut into narrower widths, such as 6 to 9 inches, and are self-wound.

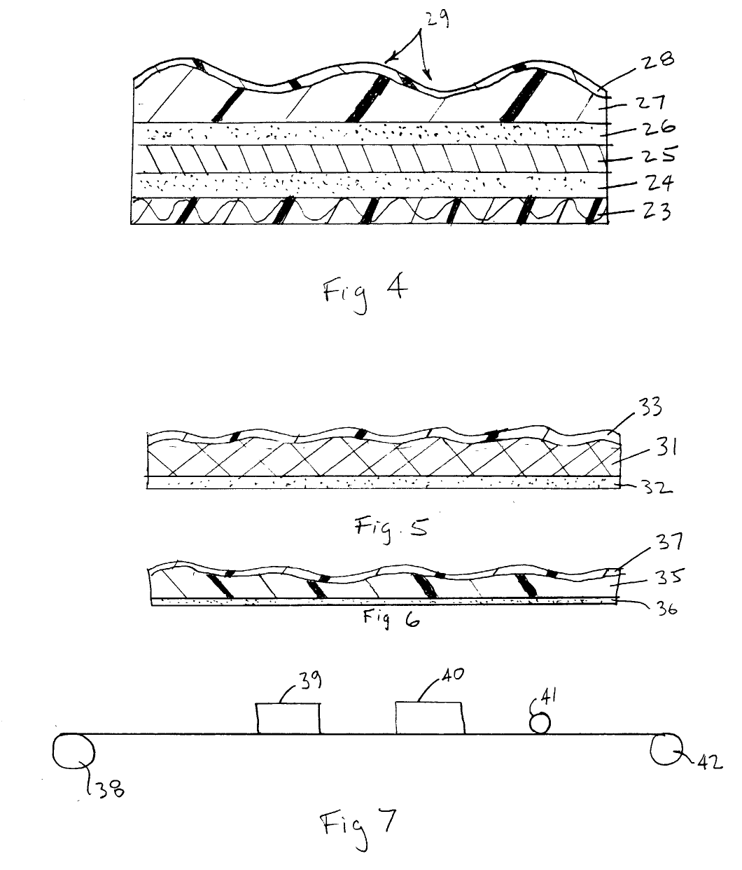

FIG. 7 illustrates the process of manufacture of a surface laminate. Based on the desired color, white or clear, metallized PVF sheet is unwound from a unwinding station 38. A bonding adhesive of desired thickness is applied at the adhesive applicator 39. Coating thickness is precisely controlled using automated systems. After this application, the adhesive is allowed to cure by air cooling. PET fabric is applied to the adhesive side of the sheet at the fabric applicator 41. This laminate is pressed using press rollers and then wound into rolls at the winder 42. In case of silver laminate, a clear, PVF sheet is metallized on one surface in a separate process before this lamination. Such metallized sheet is loaded at the unwinding station 38 such that the metallized surface will be adhesive coated at the adhesive applicator 39. The production of a surface laminate comprised of fabric, foil and sheet is performed as a two-step process. PVF sheet and aluminum foil are initially bonded together using an adhesive. The aluminum foil surface of such laminate is in turn laminated to a PET fabric using an adhesive and such structure is subsequently wound into rolls.

A seam tape may be obtained by slitting any of the above-mentioned sheets into narrower widths using a slitting device. Seam tape with the aforementioned reflectivity and emissivity may be used around the base of chimneys and other roof penetrations, and may be used to repair or supplement a lap joint.

The foregoing detailed description shows examples of embodiments of the present inventions. It will be understood by those of skill in the art that the inventions described herein, as claimed below, may be practiced in a number of alternative ways and that variations and modifications from the embodiments shown and described herein may still embody the spirit and scope of the appended claims.

What is claimed is:

1. A highly reflective and highly emissive laminate for use in restricting the passage of radiant energy through the surface of a structure comprising:
a reflective and emissive sheet,
a fabric, said sheet being carried by said fabric,
whereby radiant energy hitting an upper of said sheet is reflected and emitted upwardly away from said fabric.

2. A highly reflective and highly emissive laminate as described in claim 1, wherein:
said sheet is rendered ultraviolet resistant by an ultraviolet resistant coating material carried by the upper surface of said sheet.

3. A highly reflective and highly emissive laminate as described in claim 1, wherein:
an ultraviolet resistant material is mixed with material comprising said sheet.

4. A highly reflective and highly emissive laminate as described in claim 1, wherein:
said sheet is comprised of PVF, and said fabric is comprised of PET.

5. A highly reflective and highly emissive laminate as described in claim 1, wherein:
the upper surface of said laminate is embossed to reduce the slipperiness of said upper surface.

6. A highly reflective and highly emissive laminate as described in claim 1, wherein:
a metal layer is carried by said sheet,
said metal layer being selected from the group consisting of: a vapor deposited metal layer applied directly to said sheet, and a discrete metal sheet adhered to said sheet by a bonding adhesive.

7. A highly reflective and highly emissive laminate as described in claim 1, wherein:
a white pigment is incorporated into material comprising said sheet.

8. A highly reflective and highly emissive laminate as described in claim 1, wherein:
said sheet is translucent and a white-colored bonding adhesive adheres said sheet to said fabric.

9. A highly reflective and highly emissive laminate as described in claim 1, wherein:
said laminate contains a sheet of aluminum foil disposed between said sheet and said fabric.

10. A highly reflective and highly emissive laminate as described in claim 1, wherein:
said laminate is cut into sections to provide a seam tape.

11. A laminate for use in a roof covering to restrict the passage of radiant energy to the interior of a structure comprising:
a reflective and emissive sheet made of PVF, a metal layer carried by an undersurface of said sheet,
a PET fabric adhered to an undersurface of said metal layer,
whereby radiant energy hitting an upper of said sheet is reflected and emitted upwardly away from said fabric.

12. A laminate as described in claim 11 wherein:
said metal layer is a vapor deposited metal layer applied directly to said sheet.

13. A laminate as described in claim 11, wherein:
said metal layer is a discrete metal sheet adhered to said sheet by a bonding adhesive.

14. A laminate as described in claim 12, wherein:
said PVF sheet is translucent.

15. A laminate as described in claim 11, wherein:
said PVF sheet is impregnated with a white pigment, whereby said metal layer reflects radiant energy passing though said PVF sheet and blocks UV light.

16. A laminate for use in a roof covering to restrict the passage of radiant energy to the interior of a structure comprising:
a reflective and emissive sheet made of PVF,
a PET fabric below said sheet,
whereby radiant energy hitting an upper of said sheet is reflected and emitted upwardly away from said fabric.

17. A laminate as described in claim 16 wherein:
a vapor deposited metal layer is carried by said sheet.

18. A laminate as described in claim 16, wherein:
a discrete metal sheet is adhered to said sheet by a bonding adhesive.

19. A laminate as described in claim 16, wherein:
said PVF sheet is opaque and is impregnated with a white pigment, whereby said sheet reflects radiant energy.

20. A laminate as described in claim 16, wherein:
said PVF sheet is translucent.

21. A laminate as described in claim 16, wherein:
said PVF sheet carries a UV resistant coating on the upper surface of said sheet, and said UV coating is impregnated with a white pigment, whereby said coating reflects radiant energy.

22. A laminate as described in claim 16, wherein:
said PVF sheet is translucent and said sheet is adhered to said PET fabric by an adhesive impregnated with a white pigment, whereby said adhesive reflects radiant energy.
